(19) United States
(12) Patent Application Publication
(10) Pub. No.: US 2011/0228974 A1
(43) Pub. Date: Sep. 22, 2011

(54) OBJECT OCR AND LOCATION TAGGING SYSTEMS

(76) Inventor: Henry S. King, Moraga, CA (US)

(21) Appl. No.: 13/051,850

(22) Filed: Mar. 18, 2011

Related U.S. Application Data
(60) Provisional application No. 61/315,252, filed on Mar. 18, 2010.

(51) Int. Cl. G06K 9/00

(52) U.S. Cl. 382/101; 382/105

(57) ABSTRACT

A handheld device is disclosed generating a tagged image of an indicator on an object. The tagged image may include an image of the indicator and a location associated with the object. A processor receives the tagged image and responds by performing Optical Character Recognition (OCR) on the image to create an indicator code. A database may be updated based upon the indicator code and the location and a report may be generated. The handheld device and processor may communicate directly and/or through a communication device and/or a server. Revenues may be generated by authenticated access to the processor, the OCR operation and/or the operations of the database. The object may be a container at least twenty feet long and/or a chassis configured to haul the container. Alternatively, the object may be a small object configured to fit in the container.

### CROSS REFERENCE TO RELATED APPLICATIONS

This application claims priority to Provisional U.S. Patent Application No. 61/315,252 entitled “Container Chassis OCR Geotagging System” by inventors Henry King and Toru Takehara, filed Mar. 18, 2010.

### TECHNICAL FIELD

This application discloses two sets of embodiments related to the Image Capture, Archiving, and Optical Character Recognition (OCR) of tagged images of an object to create an indicator code. The tagged images are generated by a handheld device and include at least one image of an indicator on the object and a location of the object. The indicator code and the location are then used to track the location of the object and possibly its status, such as the temperature in a refrigerated container. The object in the first set of embodiments may include a container and/or a container chassis. In the second set of embodiments, the object may be a small object such as a package, box or pallet that may be transported in a container.

### BACKGROUND OF THE INVENTION

Today, there is a large amount of transportation of containers. Trucks pull chassis that carry one or more of these containers, which are at least twenty feet long. Companies that provide these transportation services must keep track not only of the containers, but also of the chassis. Both use a standard identification, optically visible lettering, that indicates the identity of the container or the chassis. A database of the objects that includes their location is often used to manage these objects. Such databases may also include insurance reports estimating the damage to the container and/or the chassis. Also there are special reporting requirements for refrigerated containers. In several countries such as the United States, records must be kept of their internal temperature.

Also today, there is a large and growing industry that transports smaller objects, such as boxes and/or packages, often in response to specific purchases made by individuals using ecommerce web sites that link businesses of every size to these individuals. These businesses have similar needs to the container transport companies. They initiate and/or manage delivery of these small objects throughout the United States and often, much of the rest of the world. They must keep track of the small objects, where they are located, and whether they are damaged or stolen. In many situations, documenting where the damage may have originated and the nature of those damages may be very important for insurance purposes. And even more than for container transport companies, the overhead for these tracking activities must be kept to a minimum.

### SUMMARY OF THE INVENTION

Two sets of embodiments of the invention are disclosed that aid in managing objects and their storage, transport and delivery. The first set of embodiments aid in managing large objects such as containers at least twenty feet in length and/or a chassis configured to carry at least one of the containers. The second set of embodiments aid in managing small objects that may be transported in a container, such as packages, boxes and/or pallets.

A handheld device may be used to generate a tagged image of an indicator that may serve as an identification marking on the side of the object. The indicator may also be any readable marking of the object. The tagged image may include an image of the indicator and a location associated with the object.

A processor receives the tagged image and may respond by performing Optical Character Recognition (OCR) on the image to create an indicator code and/or perform another image processing algorithm to facilitate identification of the object, damage inspection and/or analyze/assess other anomalies of the image and/or the object.

A processed result may include the indicator code and the location to help locate and identify the object.
The indicator on the object for the first set of embodiments may include an identifier on the container, a temperature reading of a temperature inside the container, a chassis identifier on the chassis, a license plate of the chassis, a hubometer to determine the total travel of the chassis and/or the tread wear on a tire of the chassis.
The indicator for the second set of embodiments may include a label, a mailing label and/or a return label on the small object.
Other example indicators that may apply to both sets of embodiments include a time of capture of the image, a user identification of the handheld device and/or any notes entered by the person using the handheld device.

The processed result may also include the image. The tagged image may be used for an insurance estimate about the object in situations where the object may be damaged or worn, such as tires that may show signs of wear. The insurance estimate and/or the image used for the estimate may also be included in the processed result.

The processed result may be used to update a database about the object. This database may be used to generate a report about the object and its location, which may further include the internal temperature for refrigeration containers, insurance related images and reports. The embodiments may determine that the OCR results are inaccurate and may trigger an audit of the image to create an indicator audit estimate.

The processor may be configured to enable authenticated access for receipt of the tagged image. A communication device may be configured to access the handheld device to send the tagged image to the processor. A backend web server hosting a website may be used to provide the tagged image to the processor. A user web site may be used to access the database and/or reports and/or the processed results generated by the processor.

In any of these embodiments, revenue may be created. A second revenue may be created in response to the processor performing OCR. A third revenue may be, at least in part, created by the database generating a report of the object. A fourth revenue may be indirectly created by allowing for a faster turn time of leased equipment between entering and leaving a container terminal gate by eliminating paperwork delays from the use of this automated system.

### BRIEF DESCRIPTION OF THE DRAWINGS

FIG. 1 shows an example using the first set of embodiments, of a handheld device generating a tagged image of an indicator on the side of a large object such as a container and/or a chassis configured to transport the container. A processor receives the tagged image and responds by performing Optical Character Recognition (OCR) on the image to create an indicator code. The processed result may be used to update a database about the object and the database may create a report about the object.

FIG. 2 shows examples of the indicators for containers and chassis as seen on the front and/or back of the chassis, which may have license plates on the front and back. Another indicator may include the license plate of the truck shown in FIG. 1 that hauls the chassis.

FIG. 3 shows the tagged image with a damage indicator that may be used for an insurance estimate about the object. Note that these indications of damage may be circled by the operator of the handheld device shown in FIG. 1.

FIGS. 4A and 4B show the insurance estimate and/or the image used for the estimate may also be included in the processed result. The indicator code may include the container indicator and the damage indicator. The processed result may also include the user identifier who captured the image, audited (reviewed) the image, and/or made notes entered to produce the processed result.

FIG. 5A shows a communication device configured to access the handheld device to send the tagged image to the processor to create the revenue.

FIG. 5B shows a web site used to provide the tagged image to the processor to create the revenue.

FIG. 6 shows some example components the handheld device of FIG. 1 may use and/or include to at least partly create the location.

FIG. 7A shows some communication components of the communication device or of the handheld device.

FIG. 7B shows some examples of an access portal that may be used by the communication device to send the tagged image.

FIGS. 8A and 8B show some examples of the components of the processor.

FIG. 8C shows a refinement of FIG. 1 further including an Optical Character Recognition component, a web server, terminal operating system and/or fleet management system as well as several human interfaces.

FIG. 9 shows an example of the details of the program system of FIG. 8.

FIGS. 10A and 10B show some details of the storage of the chassis that may be reported by the database and recorded by the handheld device.

FIG. 10C shows an example of a parked chassis with a container loaded on it.

FIG. 10D shows an example of the use of the handheld device by the user creating at least one image of a truck pulling a chassis loaded with at least one container.

FIG. 11 shows an example the second set of embodiments of a handheld device generating a tagged image of an indicator on the side of a small object. The small object may include a package, a box and/or a pallet that may be transported in the container of FIG. 1. The processor receives the tagged image and responds by performing Optical Character Recognition (OCR) on the image to create the indicator code. The processed result may be used to update the database about the small object and the database may create a report about the small object.

FIG. 12 shows a refinement of FIG. 8C and FIG. 11 further including e-commerce provider system and/or e-commerce business system as well as several human interfaces.

FIG. 13 shows an example of the details of the program system of FIGS. 8A, 8B and/or 9 configured for use with the processor as shown in FIGS. 11 and 12.

### DETAILED DESCRIPTION

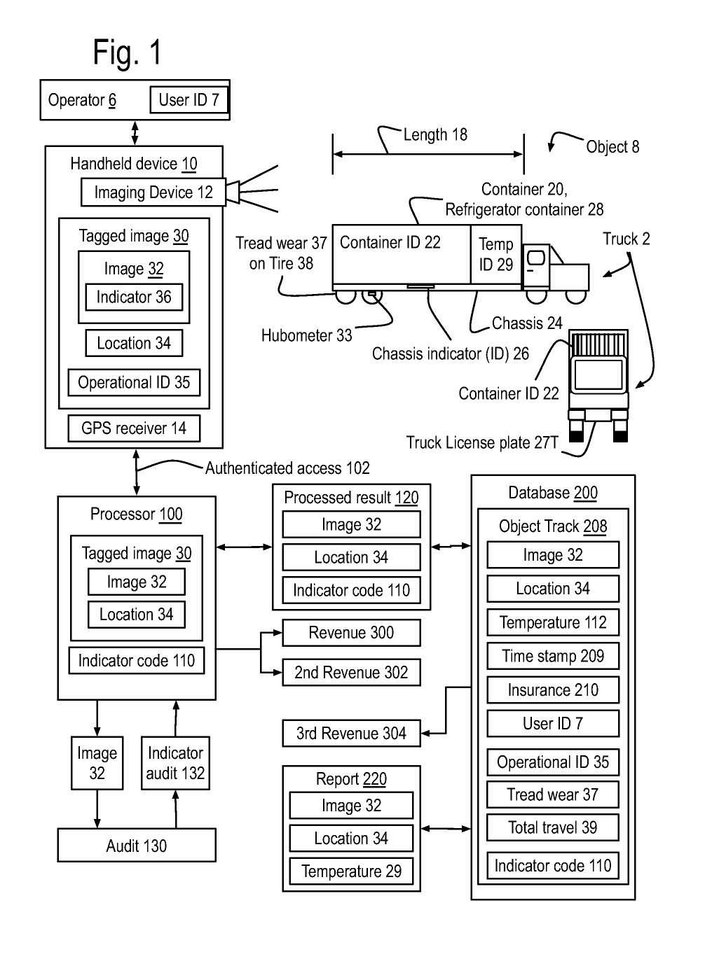

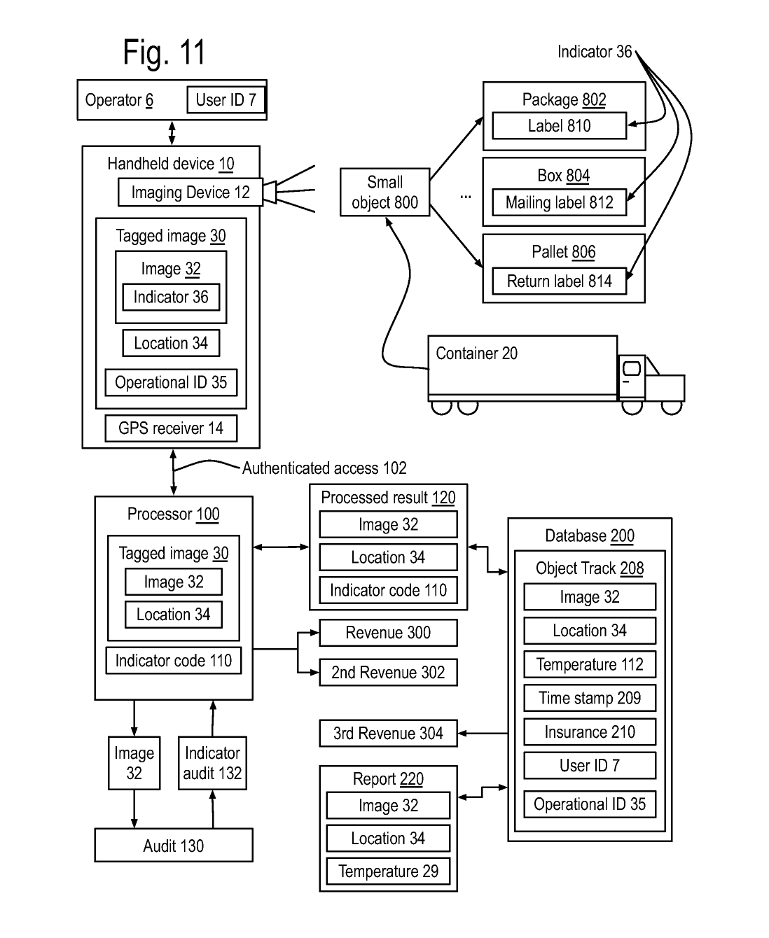

This application discloses two sets of embodiments related to the Image Capture, Archiving, and Optical Character Recognition (OCR) of tagged images of an object to create an indicator code. The tagged images are generated by a handheld device and include at least one image of an indicator on the side of the object and a location. The indicator code and the location are then used by a management system to track the location of the object and possibly its status, such as the temperature in a refrigerated container. The object in a first set of embodiments may include a container and/or a container chassis. In the second set of embodiments, the object may include a box or package that may be transported in a container. This set of embodiments is shown in FIGS. 1 to 10D. The second set of embodiments is shown starting in FIG. 11 and using some of the first embodiments Figures where appropriate.

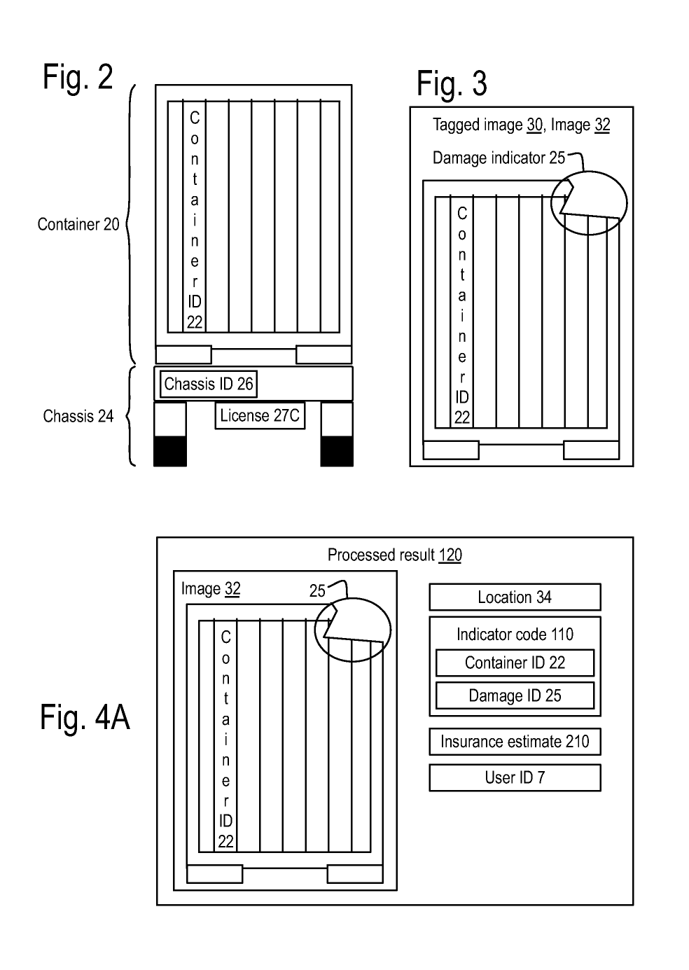

Referring to the Figures, FIG. 1 shows a system that may include components of the first set of embodiments, that aid in managing an object 8 that may include a container 20 at least twenty feet in length and/or a chassis 24 configured to carry at least one of the containers 20. A handheld device 10 may be used to generate a tagged image 30 of an indicator 36 on the object 8. Examples of indicators 36 for the containers may include container identifiers 22 for the container 20 or the refrigerator container 28, and a temperature indicator 29 for the refrigerated container 28. Examples of indicators 36 for the chassis 26 may include a chassis indicator 26 and/or a license plate 27 that is shown in FIG. 2. The license plate 27T of the truck 2 that hauls the chassis 24 may also be consider an indicator 26 of container 20 or chassis 24.

The tagged image 30 may include an image 32 of the indicator 36 and a location 34 associated with the object 8. A processor 100 may be configured to receive the tagged image 30 and respond by performing Optical Character Recognition (OCR) on the image 32 to create an indicator code 110.

The indicator code 110 and the location 34 may be used to update a database 200 regarding the object 8. The indicator code 110 and the location 34 may be used as a processed result 120 to update the database 200 about the object 8, shown here as the object track 208, that may include the image 32, its location 34, the temperature 110 as a temperature indicator 29 of the temperature inside a refrigerated container 28.

The database 200 may be used to generate a report 220 about the object 8 and its location 34, which may further include the internal temperature 29 for refrigeration containers 28, insurance 210 related images and reports. In some implementations, the OCR results may be inaccurate and may trigger an audit 130 of the image 32 to create an indicator audit estimate 132.

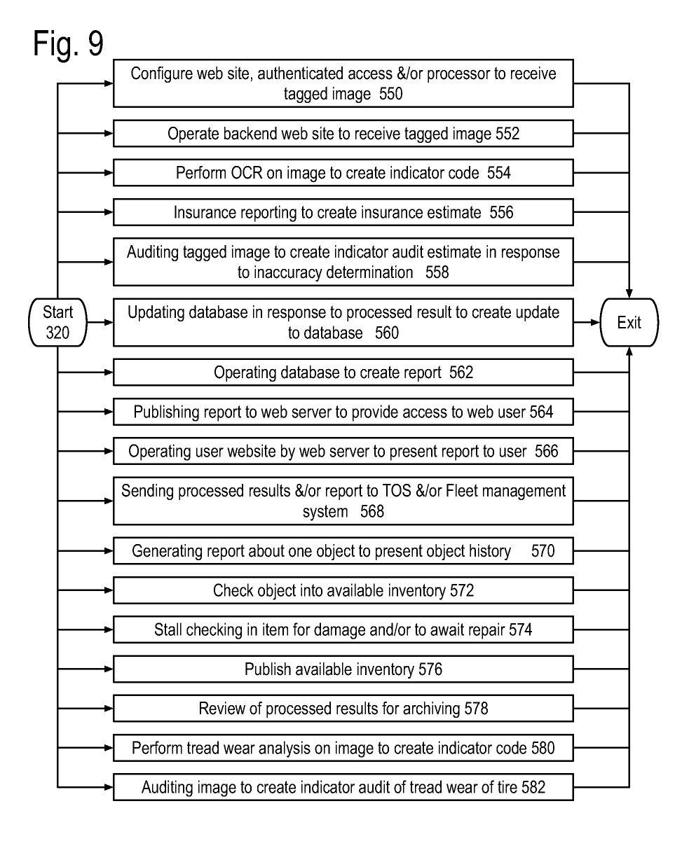

In some implementations, another of the indicators 36 on the chassis 24 may include the tread wear 37 of one or more, of the tires 38 of the chassis 24. The tread wear 37 refers to the pattern of grooves and/or ridges in a tire 38 that may indicate 36 how much longer the tire 38 may be used safely.
The handheld device 10 may be used to capture images 32 of the tread wear 37 on each of the tires 38 of the chassis 24.
The tagged image 30 of the tread wear 37 on the tires 38 may be received by the processor 100, which may employ a tread wear analyzer, as shown in program step 580 of FIG. 9, to create an indicator code 110 of the tread wear 37 on the tire 38.
The object track 208 may also include indicator codes 110 and/or images 32 of the tread wear 37 on the tire 38 on the chassis 24.

Yet another indicator 36 on the chassis 24 may include a hubometer 33 that may indicate a total travel 39 for the chassis 24, which is an estimate or measure of the total distance that the chassis 24 has traveled based upon the number of revolutions the axle has turned. The hubometer 33 may be attached or mounted on an axle of the chassis 24.
The handheld device 10 may be used to generate an image 32 of the hubometer 33 that indicates the total travel distance 39 of the chassis 24.
The object track 208 may also include indicator codes 110 and/or images 32 of the indicator 36 in the hubometer 33 on the chassis 24.

An operator 6 may control the handheld device 10. The operator 6 may use a user identification 7 to gain access to the hand held device 10. The hand held device 10 may include an operational identifier 35 to identify the device used to create the tagged image 30.

In some embodiments, a tagged image 30 may embed data in at least one JPEG image, for example, as information embedded in an image data structure component often referred to as the metadata, which may be stored in a variety of ways, such as Exchangeable image file format (EXIF) and/or the Extensible Metadata Platform (XMP) format, which do not tend to be visible in the picture itself but may be read and written by special programs and many digital cameras and/or scanners.

The location 34 may be stored as latitude and longitude in units of degrees with decimal. This tagged image 30 may be said to have geotag information that can be read by programs, such as the cross-platform open source tool ExifTool.

Alternatively, the image 32 and/or the tagged image 30 may be in another format, for instance, in TIF or GIF. Such formats may also support the use of metadata to embed location and indicator codes. In yet other embodiments, the tagged image 30 may differ from the image 32 by the injection of encrypted noise added to the image that communicates the location 34 and/or the indicator code 110 in a format that may be computationally hard to decypher without a decryption key. In some embodiments, the encrypted information may also act as a digital watermark that can be used to tell if the image 32 has been altered.

A processed result 120 may include one or more indicator codes 110 and the location 34 to help locate and identify the object 8. The processed result may also include the image 32, the temperature indication 112, a time stamp 209, which may have been embedded in the tagged image 30 as well as possibly the operator identifier 7 of the handheld device 10.

The database 200 may interact with the processed result 120 to create and/or alter an object track 208 that may include combinations of the image 32, the location 34, the temperature 112, a time stamp 209, which may originate with the hand held device 10 and/or the processor 100, an insurance estimate 210, the user identification 7, and/or the operational identifier 35 of the hand held device 10.

When the object 8 is a chassis 24, the object track 208 may also include the tread wear 37 of one or more or all of the tires 38 of the chassis 24. The object track 208 may also include the total travel 39 of the chassis 24, possibly generated by the handheld device 10 in response to an image 32 of the hubometer 33 on the chassis 24.

The report 220 may be generated through interactions with the database 200, or in other embodiments, by the database.
One example report 220 may include the image 32, the location 34 and the temperature 29 indicated for the refrigerator container 28.
Some of the reports 220 may include the location(s) 34 where the handheld device 10 created the image(s) 32 of the hubometer 33 and its indicator code 110 for the total travel 39 of the chassis 24.
Some of the reports 220 may include the location(s) 34 where the handheld device 10 created the image(s) 32 of the tread wear 37 on the tire(s) 38 of the chassis. Such reports 220 may also include one or more time stamps 209.

FIG. 2 shows examples of the indicator that includes a container indicator 22 on the side of the container 20 as well as a chassis identifier 26 of the chassis 24 and a license plate 27 of the chassis. In many situations, the container indicator 22 may be found on the front side, the backside (as shown in this Figure), the left side, the right side (as shown in FIG. 1), the top and the bottom of the container 20. The license plate 27C is often only found on the backside of the chassis as shown in this Figure. The chassis indicator is usually found only on the backside (as shown in this Figure), the left side and the right side (as shown in FIG. 1).

FIG. 3 shows the tagged image 30, in particular, the image 32 may be used for an insurance estimate about the object 8, shown here as a damaged container 20 that can be identified by the container indicator 22. The damage may be indicated by a damage indicator 25, which in some embodiments, may be drawn by the operator 6 onto the image 32 as recorded in the hand held device 10. Note that the image 32 may be circled by the operator 6 of FIG. 1 using a touchscreen 149 of the handheld device 10 shown in FIG. 6. Alternatively, the damaged may be highlighted by the operator 6 using digitizer and stylus 144.

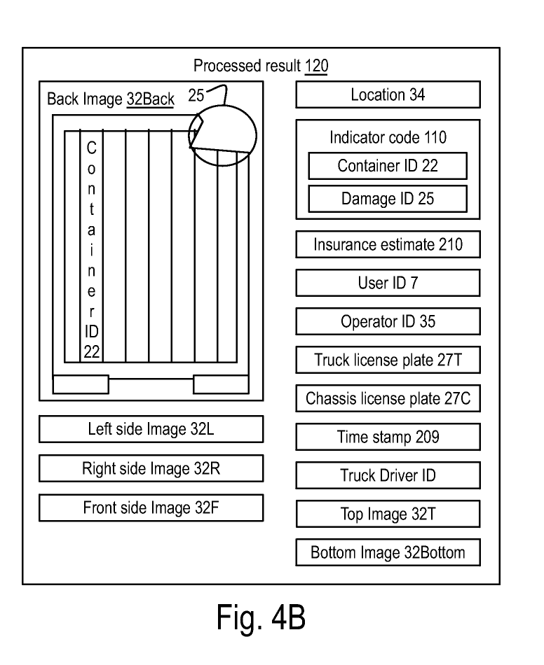

FIGS. 4A and 4B show the processed result 120 may include the insurance estimate 210 and/or the image 32 used for the estimate. The processed result 120 may include the indicator code 110, the location 34 the image 32, the temperature indication 112, a time stamp, and/or a damage indicator 25 which may have been embedded in the tagged image 30 as well as possibly an operator identifier 7 of the handheld device 10 and the truck driver identity for the operator of the truck 2.

Various embodiments may implement the authenticated access 102 differently. The processor 100 may be configured to enable authenticated access for receipt of the tagged image 30 as shown in FIG. 1.

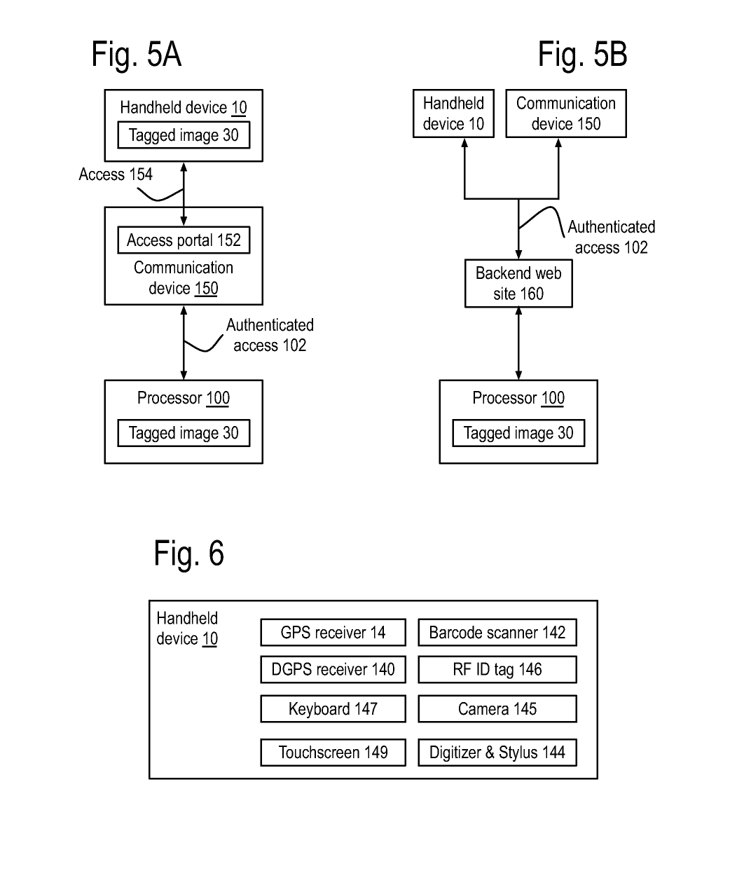

FIG. 5A shows a communication device 150 may be configured to access 154 the handheld device 10 to send the tagged image 30 to the processor 100. The communication device 150 may use an access portal 152 to access 154 the handheld device 10.

FIG. 5B shows a backend web site 160 may be used to provide the tagged image 30 to the processor 100. In any of these embodiments, the revenue 300 may be created. In various embodiments and implementations there is a possibility that two web sites may be useful. The backend web site 160 may be used by the handheld device 10 and/or the communication device 150 to provide the tagged image 30 to the processor 100, possibly using a File Transfer Protocol (FTP) or Web-based Distributed Authoring and Versioning (WebDav) protocol to send the image data to the server.

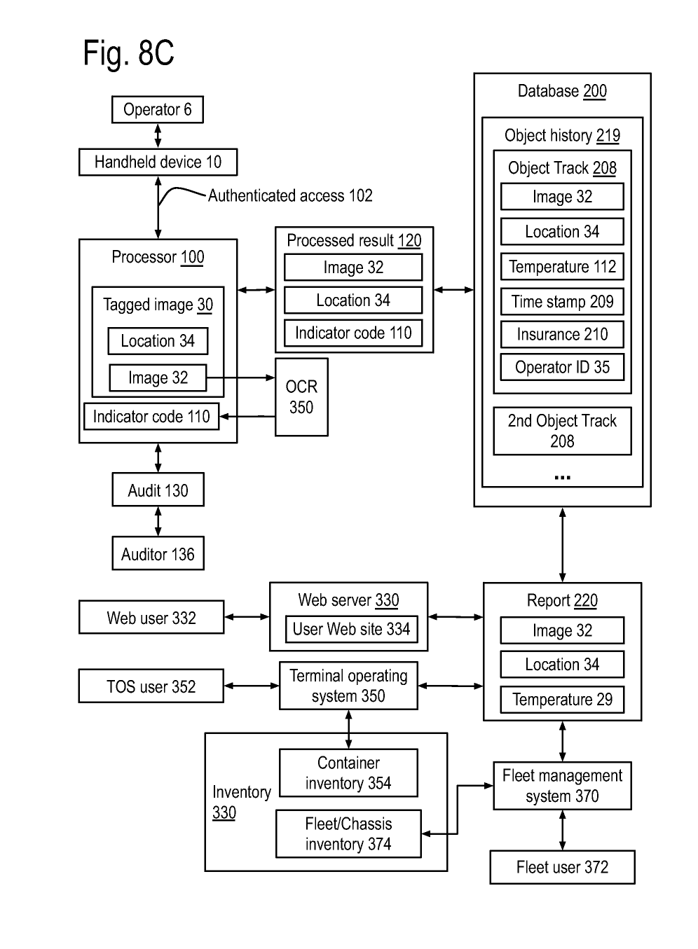

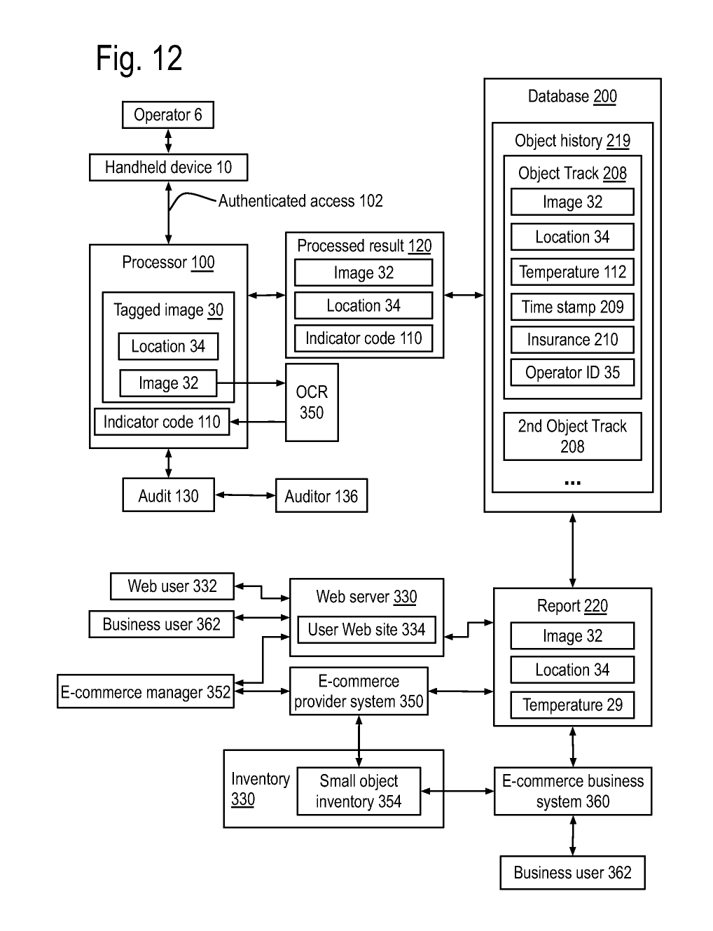

A second web site, referred to as the user web site 334 is shown in FIGS. 8C and 12. The web users 332, business users 362 and/or E-commerce managers 352 may interface and use the user web site 334.
Note that while not shown, it is also within the scope of the claims that the Terminal Operating System user 312 and/or the fleet user 322 may also interface and/or use the user web site 334.
In some implementations, the backend web site 160 and the user web site 334 may share at least an IP address, home page, or URL.
The backend web site 160 and the user web site 334 may both be operated by the web server 332.

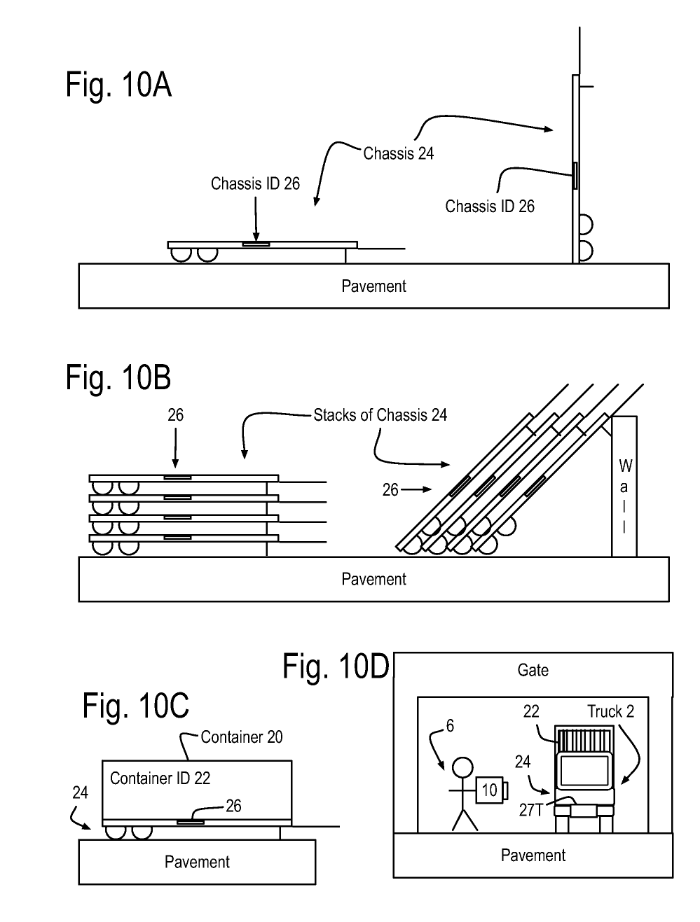

FIG. 6 shows the handheld device of FIG. 1 may include any combination of the Global Positioning System (GPS) receiver 14, a Differential GPS (DGPS) receiver 140, a barcode scanner 142 and/or a Radio Frequency IDentification (RF-ID) tag 146, to at least partly create the location 34. In certain embodiments, the barcode scanner 142 may use the imaging device 12 of FIG. 1 to acquire a version of the location that may be based on a barcode attached to a known location or a sheet with predefined locations on it. This may be aid in locating chassis 24 and/or containers 20 that may be stacked in positions that are not readily determined by GPS coordinates, as will be shown in the examples of FIG. 10 below.

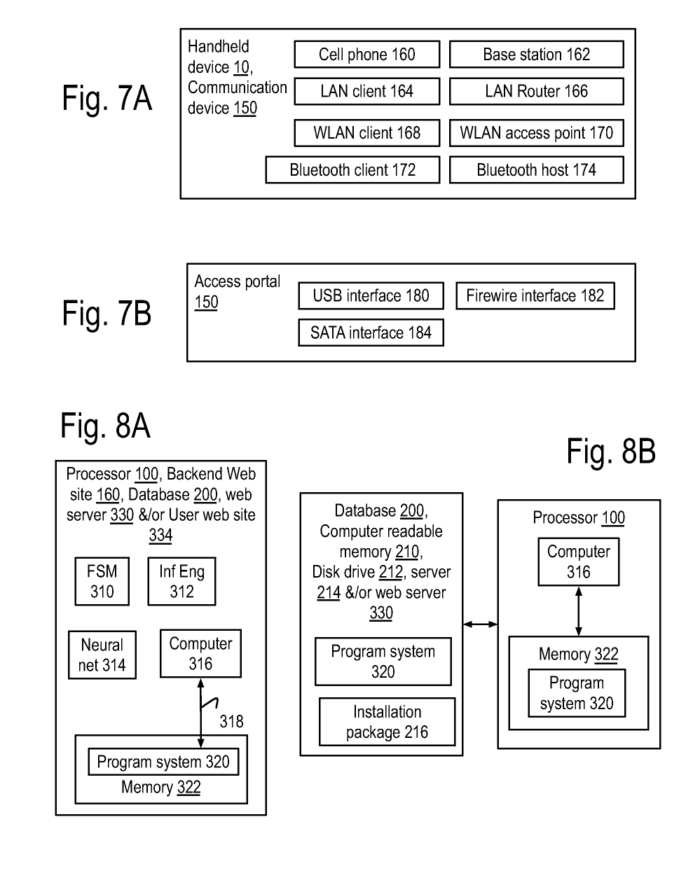

FIG. 7A shows some examples of communication components that may be included in the handheld device 10 or of the communication device 150. These examples include, but are not limited to, a cellular phone 160, a cellular base station 162, a Local Area Network (LAN) client 164, a LAN router 166, a Wireless LAN (WLAN) client 168, a WLAN access point 170, a Bluetooth client 172 and/or a Bluetooth host 174.

FIG. 7B shows some examples of an access portal 152 of FIG. 5A that may be used by the communication device 150 to access 154 the tagged image 30. The access portal may be compatible with a version of at least one of an Universal Serial Bus (USB) protocol 180, a Firewire protocol 182, and a SATA protocol 184.

FIG. 8A shows some examples of the components of the processor 100, the backend web site 160, the database 200, as well as the web server 332 and/or the web site 334 to be discussed in FIGS. 8C and 12.

The processor 100, the backend web site 160, the database 200, the web server 332 and/or the web site 334 may include at least one instance of at least one member of an implementation group consisting of members of a Finite State Machine (FSM) 310, an Inferential Engine (Inf Eng) 312, a neural network 314, and a computer 316 instructed 318 by a program system 320 residing in at least one memory 322, with at least one of the members contributing to at least partly create and/or use the processed result.
As used herein, the Finite State Machine (FSM) 310 receives at least one input signal, maintains at least one state and generates at least one output signal based upon the value of at least one of the input signals and/or at least one of the states.
As used herein, the Inferential Engine (Inf Eng) 312 includes at least one inferential rule and maintains at least one fact based upon at least one inference derived from at least one of the inference rules and factual stimulus and generates at least one output based upon the facts.
As used herein, the neural network 314 maintains at list of synapses, each with at least one synaptic state and a list of neural connections between the synapses. The neural network 314 may respond to stimulus of one or more of the synapses by transfers through the neural connections that in turn may alter the synaptic states of some of the synapses.
As used herein, the computer 316 includes at least one instruction processor and at least one data processor with each of the data processors instructed by at least one of the instruction processors. At least one of the instruction processors responds to the program steps of the program system 320 residing in the memory 322.

FIG. 8B shows some examples of the database 200, a computer readable memory 210, a disk drive 212, and/or a server 214, possibly the web server 332 of FIGS. 8C and 12, that may be configured to deliver at least part of the program system 320 in the processor 100.

The database 200, the computer readable memory 210, the disk drive 212 and/or the server 214 or 332 may deliver an installation package 216 configured to instruct the computer 316 to install at least part of the program system in the processor. As used herein, the installation package 216 may include any combination of source code, compiled modules possibly implemented as linkable libraries, and compressed versions of the program system components.

The database 200, the computer readable memory 210, the disk drive 212 and/or the server 214 or 322 may deliver the installation package and/or the program system 320 to at least partly contribute to the revenue 300, the second revenue 302 and/or the third revenue 304 of FIG. 1 and/or FIG. 11.

As used herein, a finite state machine 310 may receive at least one input, maintain at least one state and generate at least one output based upon the value of at least one of the inputs and/or at least one of the states.

As used herein, an inferential engine 312 maintains a list of inference rules and a list of facts, to which hypotheses may be presented to determine the consistency or inconsistency of the hypothesis to the facts based upon the rules of inference.

As used herein, a neural network maintains a list of neural states and a synaptic network connecting those neural states, which may be presented stimulus to trigger changes in those neural states based upon the stimulus as transferred through the synaptic network.

As used herein, a computer 316 includes at least one instruction processor and at least one data processor with each of the data processors instructed by at least one of the instruction processor based upon the program system in accord with the various embodiments of this invention, which include but are not limited to the processor 100, the backend web site 160, the database 200, the computer readable memory 210, the disk drive 212 and/or the server 214.

Note that in some embodiments the server 214 may support at least part of the backend web site 160 and/or the user web site 334.

FIG. 8C shows a refinement of the implementations previously presented and further including the database 200 including an object history 219 that includes one and often more than one object tracks 208, which may show the history of the object 8 based upon tagged images 30 taken at differing time stamps 209, Location 34, or possibly by different operator identifications 35. For example, one object track may include an insurance estimate 210 and another may not.

Also shown are several potential human interfaces that may be used in various implementations.
The audit 130 may interact with an auditor 136 to create the indicator audit 132 shown in FIG. 1. This interface may be used to improve character recognition of one of the indicators 36 such as the container identifier 22 and/or to analyze the tread wear 37 on one of the tires 38 to create the indicator code 110 for the tread wear 37.
A web user 332 may interact with a web server 330 to view the report 220, possibly displayed as on a map at the location 34 and possibly shown with the image 32 and/or the indicator code 110. The temperature 29 may be shown to the web user as well for refrigerator containers 28. The tread wear 37 on the tire(s) 38 and the total travel 39 may be shown for the chassis 24. The web server 330 may operate a web site 334 to provide the interface to the web user 332.
A Terminal Operating System (TOS) 350 may interact with a TOS user 352 to present the report 220, possibly as part of the status of the terminal's operations. The TOS user 352 may respond to the report 220 by altering the operations and/or operational schedule of the terminal's resources, which may include not only trucks 2 and chassis 24, but may also include container handling equipment, such as Utility Trucks (UTRs), gantry cranes, and front end loaders (FELs) for the containers 20. Other examples of shipping equipment that may be involved, but are not shown, include barges, container ships and railroad equipment. The TOS 310 may use the report 220 to update an inventory 330, possibly a container inventory 354.
A fleet management system 320 may interact with a fleet management system user 322, referred to hereafter as the fleet user 322, to present the report 220. The fleet management system 320 may track and manage the chassis 24, the containers 20 and/or the trucks 2. The fleet user 322 may respond to the report 220 by making or altering operations and operational schedules of any of these objects 8. Maintenance and/or repair of the chassis 24 and/or the truck 2 may be scheduled, such as changing the tires 38 and adjusting the brakes. The fleet management system 320 may respond to the report 220 by altering the inventory 330, possibly a fleet and/or chassis inventory 324.

The report 220 may integrate the location 34 and the time stamps 209 to present the object history 219 of the object 8. The object may be presented as a container 20 or a refrigerator container 28 identified by its container indicator 22 on a chassis 24 identified by its chassis indicator 26 being hauled by the truck 2 identified by its truck license plate 27T.

Optical Character Recognition (OCR) 350 may be a separate system component receiving a version of the image 32 to create the indicator code 110. In various embodiments, the images 32 may include any or all of the container indicator 22, the temperature indicator 29 of the refrigerator container 28, the chassis indicator 26, the truck license plate 27T, the chassis license plate 27C, a barcode designation of the location 34 and/or the operator indicator 35 of the handheld device 10.

In some implementations, the database 200 may be included in any combination of the following: the web server 330, the Terminal Operating System (TOS) 350 and/or the fleet management system 370. In these situations the third revenue 304 may be part of the revenue of providing any of these components, either in terms of its initial purchase price, installation expenses, maintenance fees and/or service fees.

The next Figure shows a flowchart of some details of the program system 320 instructing the processor 100 of FIGS. 8A and 8B. These flowcharts show some method embodiments, which may include arrows signifying a flow of control and/or state transitions as well as sometimes position data, supporting various implementations. These may include a program operation, or program thread, executing upon the computer 316 or states of the finite state machine 310. Each of these program steps may at least partly support the operation to be performed. The operation of starting a flowchart refers to entering a subroutine or a macroinstruction sequence in the computer or of a possibly initial state or condition of the finite state machine. The operation of termination in a flowchart refers to completion of those operations, which may result in a subroutine return in the computer or possibly return the finite state machine to a previous condition or state. A rounded box with the word “Exit” in it denotes the operation of terminating a flowchart.

FIG. 9 shows an example of the details of the program system 320 of FIGS. 8A and 8B. The program system may include at least one of the following program steps:
Program step 550 supports configuring the backend web site 160, the authenticated access 102, and/or the processor 100, for the processor to receive the tagged image 30.
Program step 552 supports operating the backend web site 160 to receive the tagged image 30.
Program step 554 supports performing the OCR on the image 32 to create the indicator code 110.
Program step 556 supports insurance reporting at least one insurance image 30 as shown in FIG. 3 included in the tagged image 30 to contribute to creating an insurance estimate 210 of the object 8 as shown in FIG. 4.
Program step 558 supports auditing 130 the tagged image 30 to further create the indicator audit estimate 132 in response to an inaccuracy determination of the indicator code 110 of the image 32.
Program step 560 supports updating a database 200 of the objects 8 in response to the processed result 120 to create an update of the database.
Program step 562 supports operating the database 200 to create the report 220 of the object 8 based upon the indicator code 110 and/or the location 34.
Program step 564 supports publishing the report 220 to the web server 330 to provide access to the web user 332.
Program step 566 supports operating a web site by the web server 330 to present the report 220 to the web user 332.
Program step 568 supports sending the processed results 120 and/or the report 220 to the Terminal Operating System (TOS) 310 and/or fleet management system 320.
Program step 570 supports generating the report 220 about one object 8 to present at least part of the object history 219.
Program step 572 supports checking in an object 8 into an available inventory 330.
Program step 574 supports stalling the checking in of the object 8 for damage and/or to await repair of the object.
Program step 576 supports publishing the available inventory 330.
Program step 578 supports reviewing the processed results 120 for archiving.
Program step 580 supports performing tread wear analysis on the image 32 to create the indicator code 110 of the tread wear 37 on the tire 38.
Program step 582 supports auditing the image 32 to create an indicator audit 132 of the tread wear 37 of the tire 38.

FIGS. 10A-10C shows some details of the storage of the chassis 24 that may be reported by the database 200 and recorded by the handheld device 10.

FIG. 10A shows the chassis may be stacked vertically as shown on the left or stacked horizontally as shown on the right. In both situations, there is a limited ability for any form of GPS readings to clearly designate the locations of the chassis in either stack, and the operator 6 of the handheld device 10 may use a bar code scanner 142 to read-off locations in a stack, or to locate the stack in a storage yard or transfer facility.

FIG. 10B shows stacks of the chassis 24 either vertically on the pavement as shown on the left or often at a slant against a wall as shown on the right.

FIG. 10C shows a chassis 24 parked while carrying the container 20.

FIG. 10D shows the truck 2 hauling the chassis 24 loaded with the container 22 through a gate and the operator 6 operating the handheld device 10 in accordance with the methods and apparatus of this disclosure.

The object 8 in the first set of embodiments may include the container 20 and/or the container chassis 24, which has been discussed in FIGS. 1 to 10D. In the second set of embodiments, a small object 800 may include at least package 802, at least one box 804 and/or at least one pallet 806 that may be transported in the container 20 of at least twenty feet in length 18 as shown in FIG. 11.

FIG. 11 shows an example the second set of embodiments of a handheld device 10 generating a tagged image of an indicator 36 on the small object 800. Examples of the indicators 36 on the small object 800 may include, but are not limited to, a label 810, a mailing label 812 and/or a return label 814 The processor 100 receives the tagged image 30 and responds by performing Optical Character Recognition (OCR) on the image to create the indicator code 110. The processed result 120 may be used to update the database 200 about the small object 800 and the database may create a report 220 about the small object 800.

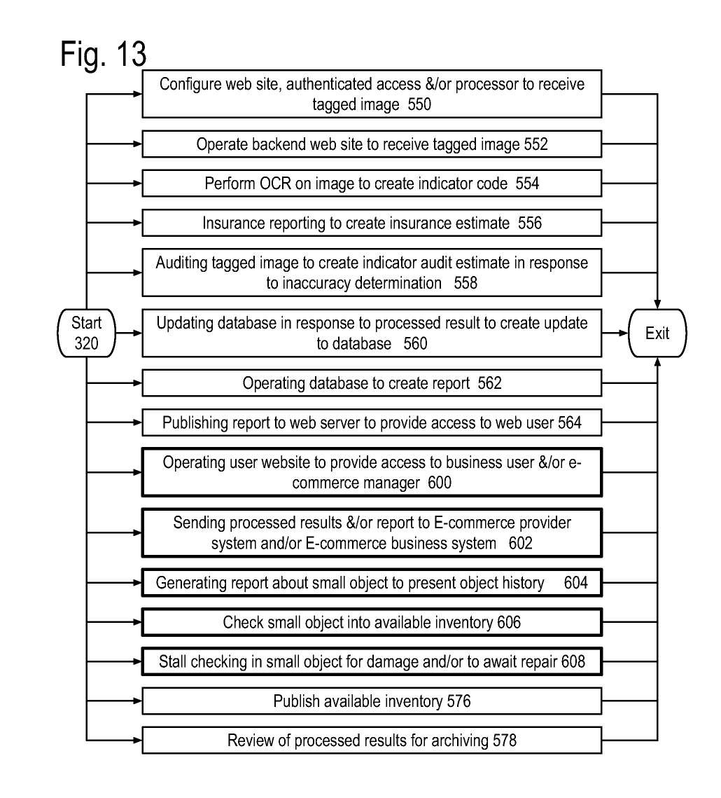

The discussion of the various implementations of the processor 100, the database 200, the handheld device 10 and the overall system are follow the same discussion and Figures as shown and discussed with regards to FIGS. 1 to 9, with the following refinements and alternatives shown in FIGS. 12 and 13.

FIG. 12 shows a refinement of FIG. 8C and FIG. 11 further including an e-commerce provider system 350 and/or an e-commerce business system 360. Additional human interfaces for the E-commerce manager 352 and the business user 362 may include interfaces with the web server 330, and possibly the same or differing web sites 334. The E-commerce manager 352 may interact with the e-commerce provider system 350 separate from what the web user 332 can access. Similarly, the business user 362 may interact with the e-commerce business system 360 separate from what the web user 332 can access.

As used herein, an e-commerce business system 360 may operate at least one business that interacts with customers across networks using communications protocols such as the Internet Protocol to form contracts. The business executes its part of the contract by delivering at least one small object 800 to someplace and/or someone as designated by the contract.

As used herein, an e-commerce provider system 350 provides a consistent interface to two or more of the e-commerce business systems 360, allowing the web user 332 to interact with any of these e-commerce business systems to create contracts for the delivery of the small objects 800.

The small object 800 may arrive damaged in a fashion similar to that shown in FIGS. 3 to 4B, where the damaged part can be highlighted as shown.

In other situations, the damage may be in the form of an incomplete package 802 or packing list for a box 804, or inoperable devices in the package or box.

In other situations, the pallet 806 may have the wrong number of boxes 804 or packages 802. In some situations, tagged images 30 from the point of entry into a warehouse until the shipping time of the pallet may serve to indicate when a theft may have occurred.

The inventory 330 may be altered and/or refined to implement a small object inventory 354, which may for example, designate locations of an available small object 800 in terms of not only buildings, storage yards, lots, rows and slots, but possibly also in terms of shelves.

As before, the Optical Character Recognition (OCR) 350 may be a separate system component receiving a version of the image 32 to create the indicator code 110.
The images 32 may include any or all of the label 810, the mailing label 812, and/or the return label 814, as well as, a barcode designation of the location 34 and/or the operator indicator 35 of the handheld device 10.

The audit 130 may interact with an auditor 136 to create the indicator audit 132 shown in FIG. 11. This interface may be used to improve character recognition of one of the indicators 36 such as the label 810, the mailing label 812, and/or the return label 814.

FIG. 13 shows an example of the details of the program system 320 of FIGS. 8 and 9 configured for use with the processor 100 of FIGS. 11 and 12. There are some alternative program steps that are specific to the second set of embodiments, which have slightly thicker borders in this Figure:
Program step 600 supports operating the website 334 to provide access to the business user 362.
Program step 602 supports sending the processed results 120 and/or the report 220 to the E-commerce provider system 350 and/or the e-commerce business system 360.
Program step 604 supports generating the report 220 about the small object 800 to present its object history 219.
Program step 606 supports checking the small object 800 into the inventory 330 as available, possibly the small object inventory 354.
Program step 608 supports stalling the checking in of the small object 800 for damage and/or to await repair.

Note that many of the program steps of FIG. 9 are also potentially useful and are shown in FIG. 13, in particular program steps 550, 552, 554, 556, 558, 560, 562, 564, 576, and 578. These program steps are being presented here so that the discussion of FIG. 13 can be read in one place:
Program step 550 supports configuring the backend web site 160, the authenticated access 102, and/or the processor 100, for the processor to receive the tagged image 30.
Program step 552 supports operating the backend web site 160 to receive the tagged image 30.
Program step 554 supports performing the OCR on the image 32 to create the indicator code 110.
Program step 556 supports insurance reporting at least one insurance image 30 as shown in FIG. 3 included in the tagged image 30 to contribute to creating an insurance estimate 210 of the small object 800 similar to that shown in FIGS. 4A and 4B.
Program step 558 supports auditing 130 the tagged image 30 to further create the indicator audit estimate 132 in response to an inaccuracy determination of the indicator code 110 of the image 32.
Program step 560 supports updating the database 200 in response to the processed result 120 to create an update of the database.
Program step 562 supports operating the database 200 to create the report 220 of the object 8 based upon the indicator code 110 and/or the location 34.
Program step 564 supports publishing the report 220 to the web server 330 to provide access to the web user 332.
Program step 576 supports publishing the available inventory 330.
Program step 578 supports reviewing the processed results 120 for archiving.

The preceding embodiments provide examples and are not meant to constrain the scope of the following claims.

What is claimed is:

1. An apparatus, comprising:
a processor configured to perform Optical Character Recognition (OCR) of an image of an indicator on an object to create an indicator code in response to receiving a tagged image including said image and a location associated with said object,
with a handheld device configured to generate said tagged image of said object,
with said object including at least one of a container at least twenty feet long and a chassis configured to carry at least one of said containers, and
with said indicator including at least one of an identifier on said container, a temperature reading of a temperature inside said container, a chassis identifier of said chassis, a license plate of said chassis, and a hubometer on said tire of said chassis; and
said processor is further configured to create a processed result containing said indicator code and said location to locate said object.

2. The apparatus of claim 1,
wherein said processed result further contains said image; and
wherein said tagged image further includes at least one of said images configured to contribute to an insurance estimate of said object.

3. The apparatus of claim 1, wherein said handheld device includes an imaging device configured to create said image of said object; and
said handheld device is configured to embed said location with said image to at least partly create said tagged image.

4. The apparatus of claim 3, wherein said handheld device further includes at least one of
a Global Positioning System (GPS) receiver to at least partly create said location;
a Differential GPS (DGPS) receiver to further at least partly create said location;
a barcode scanner configured to at least partly create said location; and
a Radio Frequency IDentification (RF-ID) tag to at least partly create said location.

5. The apparatus of claim 4, wherein said barcode scanner is configured to use said imaging device to at least partly create said location.

6. The apparatus of claim 1, wherein at least one communication device is configured to access said handheld device to send said tagged image via an authenticated communication to said processor.

7. The apparatus of claim 6, wherein at least one of said communication device and said handheld device includes at least one of
a cellular phone, a cellular base station,
a Local Area Network (LAN) client, a LAN router,
a Wireless Local Area Network (WLAN) client, a WLAN access point,
a Bluetooth client, and a Bluetooth host.

8. The apparatus of claim 6, wherein said communication device is configured to receive said tagged image from said handheld device via an access portal.

9. The apparatus of claim 8, wherein said access portal is compatible with a version of at least one of an Universal Serial Bus (USB) protocol, a Firewire protocol, and a SATA protocol.

10. The apparatus of claim 6, wherein said handheld device includes said communication device.

11. The apparatus of claim 6, wherein said processor is configured to receive said tagged image through a web site and/or FTP server.

12. The apparatus of claim 11, wherein a revenue is generated by said web site based upon a configuration of said web site to enable said processor to interact with said handheld device.

13. The apparatus of claim 1, wherein said processor is further configured to respond to at least one of
an inaccuracy determination of said indicator code to create an indicator audit estimate to further create said processed result including said indicator audit estimate,
said image containing a tread wear and/or defect on a tire of said chassis to create said indicator audit estimate of said tread wear and/or said defect to further create said processed result, and
said processor performing a tread wear analysis and/or a defect analysis on said image of said tread wear and/or said defect to create said indicator code of said tread wear and/or said defect.

14. The apparatus of claim 13, wherein said processor includes at least one instance of at least one member of an implementation group consisting of members of a finite state machine, an inferential engine, a neural network and a computer instructed by a program system residing in at least one memory, with at least one of said members contributing to at least partly create said processed result.

15. The apparatus of claim 14, wherein said program system includes at least one of the program steps of:
configuring at least one of a web site, said authenticated access, and said processor, to create said processed result in response to receipt of said tagged image;
operating said web site to receive said tagged image;
performing said OCR on said image to create said indicator code;
performing said tread wear analysis on said image of said tread wear to create said indicator code;
insurance reporting at least one insurance image included in said tagged image to contribute to creating an insurance estimate of said object;
auditing said tagged image to further create an indicator audit estimate in response to an inaccuracy determination of said indicator code;
updating a database of said objects in response to said processed result to create an update of said database; and
operating said database to provide a report of said object based upon at least one of said indicator code and said location.

16. The apparatus of claim 15, further comprising at least one of said database, a computer readable memory, a disk drive, and a server, each configured to generate at least part of said program system in said processor.

17. The apparatus of claim 16, wherein at least one of said database, said computer readable memory, said disk drive and said server further includes an installation package configured to instruct said computer to install at least part of said program system in said processor.

18. A method, comprising at least one of the steps of:
said processor of claim 1 performing said Optical Character Recognition (OCR) of said image of said indicator on said object to create said indicator code in response to receiving said tagged image including said image and said location associated with said object;
said handheld device generating said tagged image of said object; and
said processor creating said processed result containing said indicator code and said location to locate said object.

19. The method of claim 18, further comprising at least one of the steps of:
at least one communication device accessing said handheld device to send said tagged image via an authenticated communication to said processor; and
said processor responding to an inaccuracy determination of said indicator code to create an indicator audit estimate to further create said processed result including said indicator audit estimate.

20. The method of claim 19,
wherein the step of said communication device accessing further comprises the step of
said communication device receiving said tagged image from said handheld device via an access portal.

21. The method of claim 19, further comprising the step of
said processor receiving said tagged image through a web site and/or a FTP server.

22. The method of claim 21, further comprising the step of
generating a revenue based upon enabling said processor to receive said tagged image and to generate said processed result.

23. The method of claim 19, further comprising at least one of the steps of:
configuring at least one of a web site, said authenticated access, and said processor, for said tagged image to be received by said processor to create a revenue;
operating said web site to receive said tagged image;
said processor performing said OCR on said image to create said indicator code and a second revenue;
insurance reporting at least one insurance image included in said tagged image to contribute to creating an insurance estimate of said object;
auditing said tagged image to further create an indicator audit estimate in response to an inaccuracy determination of said indicator code;
updating a database of said objects in response to said processed result; and
operating said database to provide a report of said object based upon at least one of said indicator code and said location to at least partly create a third revenue.

24. The method of claim 23, further comprising the step of generating at least part of said program system in said processor by at least one of said database, a computer readable memory, a disk drive, and a server.

25. The method of claim 24, wherein at least one of said database, said computer readable memory, said disk drive and said server further includes an installation package configured to instruct said computer to install at least part of said program system in said processor.

26. The method of claim 23, wherein said method produces at least one of said indicator code, said processed result, said revenue, said second revenue, said third revenue, said insurance estimate, said inaccuracy determination, said indicator audit estimate, said update of said database, and said report.

27. An apparatus, comprising:
a processor configured to perform Optical Character Recognition (OCR) of an image of an indicator on a small object to create an indicator code in response to receiving a tagged image including said image and a location associated with said small object,
with a handheld device configured to generate said tagged image of said small object,
with said small object is configured to fit into a container at least twenty feet long, and
with said indicator including at least one of a label, a mailing label, and a return label; and
said processor is further configured to create a processed result containing said indicator code and said location to locate said object, and/or an image of any damage to object.
